(19) United States
(12) Patent Application Publication
(10) Pub. No.: US 2010/0261151 A1
(43) Pub. Date: Oct. 14, 2010

(54) SYSTEM AND METHOD FOR THE AUTOMATED TRACKING AND ANALYSIS OF EDUCATIONAL GAMES AND INTERACTIVE TEACHING TOOLS

(76) Inventors: Carl Skelton, New York, NY (US); Nikhil Gupta, Ossining, NY (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/757,457

(22) Filed: Apr. 9, 2010

Related U.S. Application Data
(60) Provisional application No. 61/168,030, filed on Apr. 9, 2009.

(51) Int. Cl. G09B 7/00

(52) U.S. Cl. 434/350

(57) ABSTRACT

An integrated system and method for the recording, collection, storage, and representation of individual and aggregate use patterns of a fully-developed matrix of interactive course materials supporting K-16 curricula in STEM (Science, Technology, Engineering, and Mathematics) subjects. Students may utilize interactive educational games to assess their performance across multiple subjects and difficulty levels of a curriculum, and obtain feedback and statistics regarding their progress in attaining educational goals.

### CROSS-REFERENCE TO RELATED APPLICATIONS

This application claims priority to U.S. provisional application No. 61/168,030, filed Apr. 9, 2009, which is incorporated herein by reference.

### BACKGROUND OF THE INVENTION

1. Technical Field

The present invention relates to systems and methods for automatically tracking and analyzing educational games and interactive teaching tools.

2. Prior Art

At present, methods for recording and describing the use of educational games, animations and interactive teaching tools make poor use of the technology they depend on: typically, instructors or graduate research assistants make subjective assessments, or record the subjective assessments of users themselves, and then spend long hours verifying and logging the “data”. These practices, being labor-intensive and requiring the presence of a qualified instructor or evaluator at every workstation for every minute of data generation, and subsequent hand entry of data, constrain the capacity of game developers to derive useful information from users, and thereby inform the ongoing game development process. At the same time, instructors are hampered as much as they are helped by computers in the classroom, due to the poor articulation of materials with curricula and the lack of a concomitant system for recording and evaluating the work of students, or measuring their progress.

While the attraction of computer games for school-age children and young adults is well-recognized, and the hope that this attraction can be leveraged to motivate students to greater participation and achievement (particularly, for example, in science and technology fields) is reasonable, the systems for assessment/evaluation data collection and representation are lagging.

### BRIEF SUMMARY OF THE INVENTION

The present invention provides for an integrated system of recording, collection, storage, and representation of individual and aggregate use patterns of a fully-developed matrix of interactive course materials supporting K-16 (Kindergarten through undergraduate) curricula in STEM (Science, Technology, Engineering, and Mathematics) subjects.

The first level of recording is the “journaling” of individual gameplay sessions on the computer being used by a student in class or at home. This function provides the ability for a teacher to replay the session at a variety of speeds, to assist the teacher in assessing the student's level of engagement, learning style, and specific areas of proficiency or need in relation to the subject matter. The second level of recording is statistical. The computer tabulates statistics about the student's use of the games/teaching modules: number of sessions, length of sessions, number of right and wrong answers sorted by subject area. Each computer may comprise a programmable logic unit, an output device, one or more input devices, and volatile and persistent storage devices.

In the classroom, data is typically aggregated through the school data network in real time. In the home, data is stored by the student's computer for subsequent downloading to the school's server when the student logs in to the system. Alternatively, an internet accessible secure account can be created to transmit the data to the school computer system either continuously or at the end of the game.

The system automatically compiles all the desired metrics in a form suitable for use by the teacher in grading and advising individual students, including the provision of information graphics to help assess individual achievement and progress over the course of a semester or a school year.

At the curriculum and learning level, the system will assist instructors in identifying the strong and weak areas in each student's knowledge even across various courses taken in different years. The knowledge deficiencies can be backtracked to their origin and resources can be committed in a specific and targeted manner.

At the school level, the system provides data to assess student achievement and progress over the course of a student career, and across subjects. This provides, at negligible cost of time or extra overhead, a richly detailed and reliable set of evaluation and assessment tools for students and teachers.

At the school board level, the system provides valuable, reliable, and complete metrics for the performance of individual schools in STEM subjects over time, to help assess, evaluate, and improve practices where needed, or to help identify particularly successful schools, whose implementation can be studied more closely as a model for their peers.

At the curriculum development level, the system assists subject matter experts and educational game designers in developing and improving the teaching tools, and the curriculum itself. The integration of STEM subjects across educational levels makes it possible to greatly improve the articulation between middle and high school, and between high school and college, two transitions which have been difficult to design for up to this point.

At the level of general issues in computing for the classroom, the system provides a valuable non-invasive resource for research and development in the academic, public education, and private sectors.

Other features, aspects, and advantages of the invention will become apparent from the following detailed description of the preferred embodiments, taken in conjunction with the accompanying drawings, illustrating by way of example the principles of the invention.

### BRIEF DESCRIPTION OF THE DRAWINGS

FIG. 1a is a flow diagram of the evaluation, assessment, and development cycle in one embodiment of the invention.

FIG. 1b is a curriculum matrix in one embodiment of the invention.

FIG. 2 is a flow diagram of an in-class student session in one embodiment of the invention.

FIG. 3 is a flow diagram of a homework or informal student session in one embodiment of the invention.

FIG. 4a is a diagram of a system in one embodiment of the invention which includes a student classroom.

FIG. 4b is a diagram of a system in one embodiment of the invention which includes a student's home.

### DETAILED DESCRIPTION OF PREFERRED EMBODIMENTS

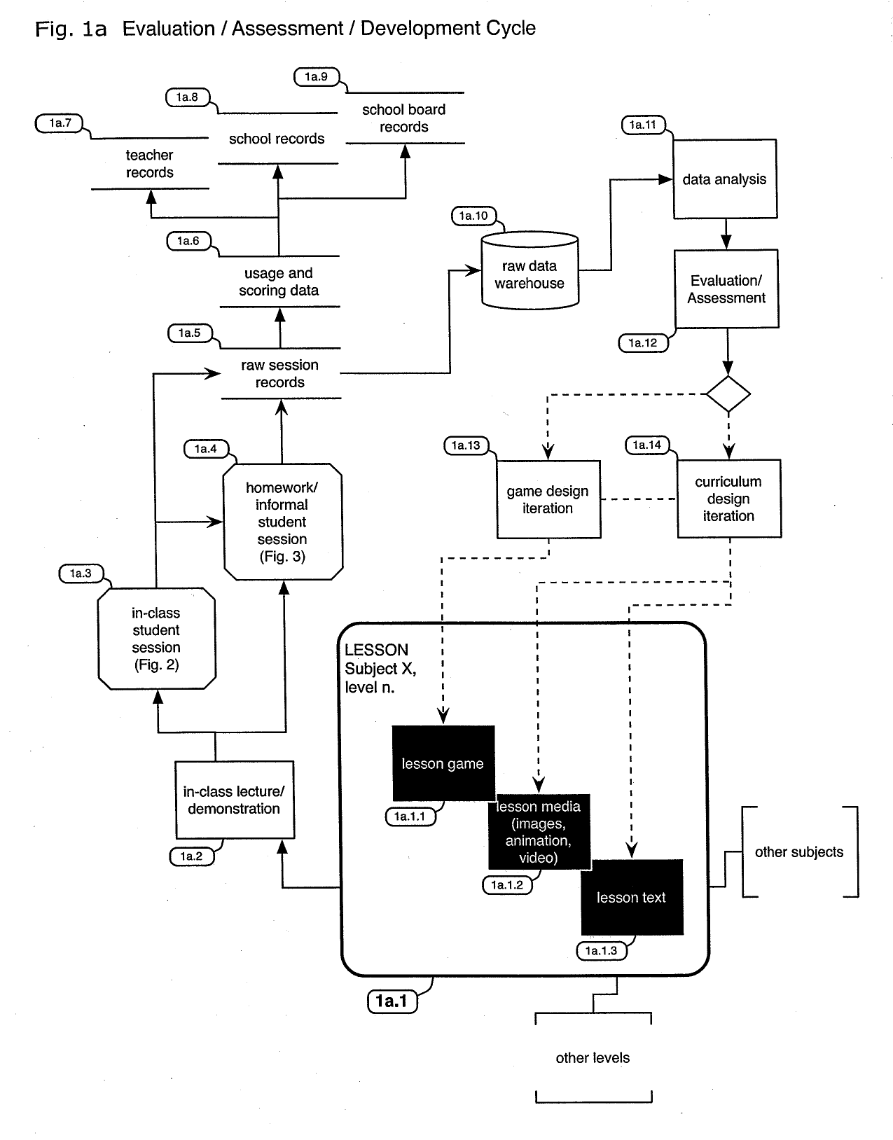

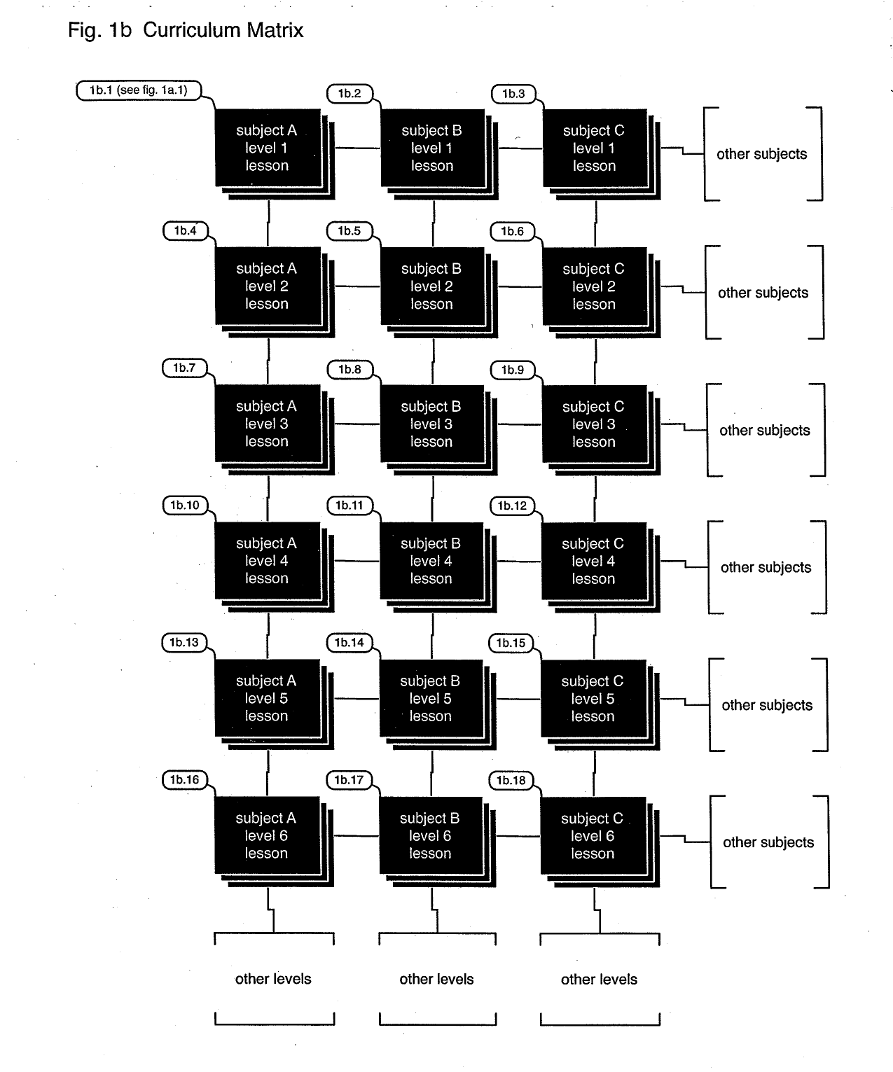

FIG. 1a is a flow diagram of the evaluation, assessment, and development cycle, showing the method in one embodiment of the invention. Item 1a.1 details the lesson for a particular subject and level. A lesson will contain a game 1a.1.1, media 1a.1.2, and text 1a.1.3. FIG. 1b shows a curriculum matrix with lessons distributed across a plurality of subjects, with each subject having multiple difficulty levels.

At step 1a.2, an instructor gives an in-class lecture or demonstration to the students. Such a lecture or demonstration may incorporate the game 1a.1.1, media 1a.1.2, and text 1a.1.3 of the lesson 1a.1.

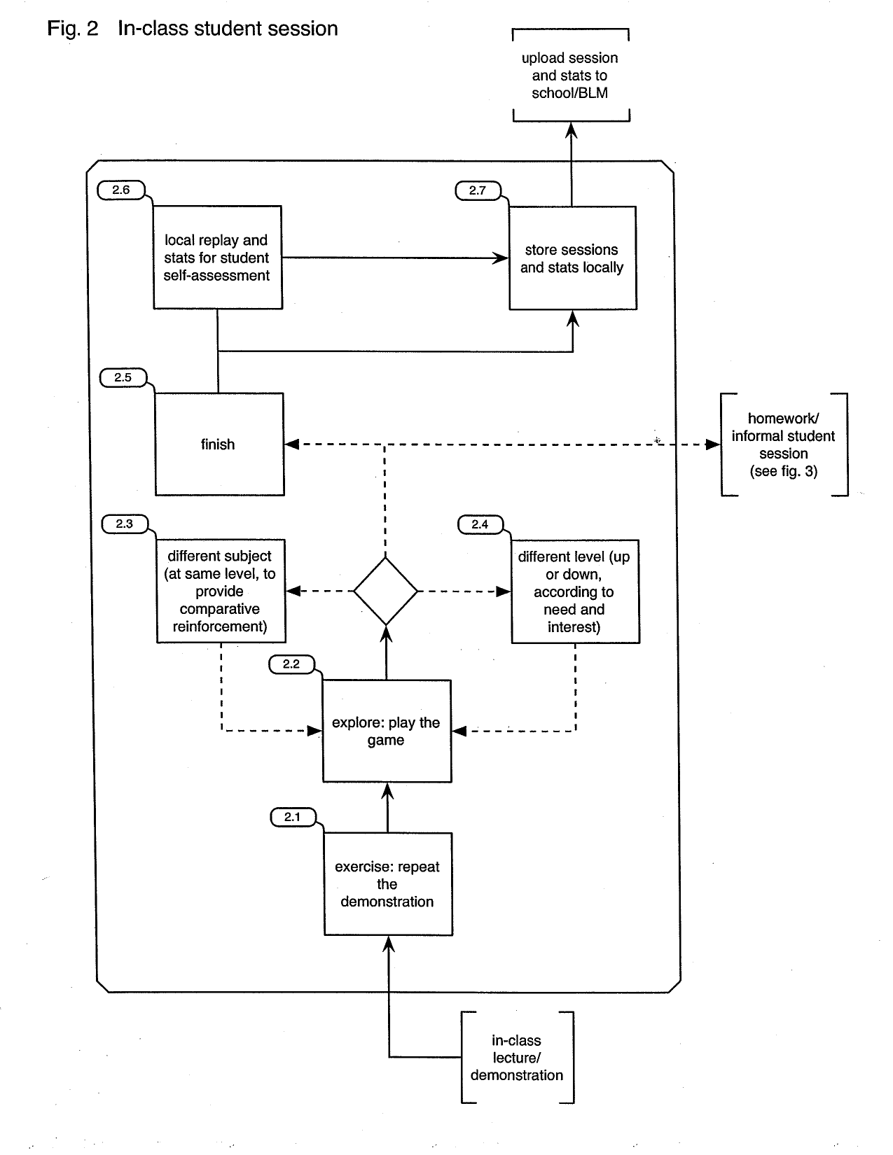

After completion of the lecture or demonstration, the student may participate in an in-class student session (step 1a.3). FIG. 2 shows a detailed flow diagram of an in-class student session 1a.3.

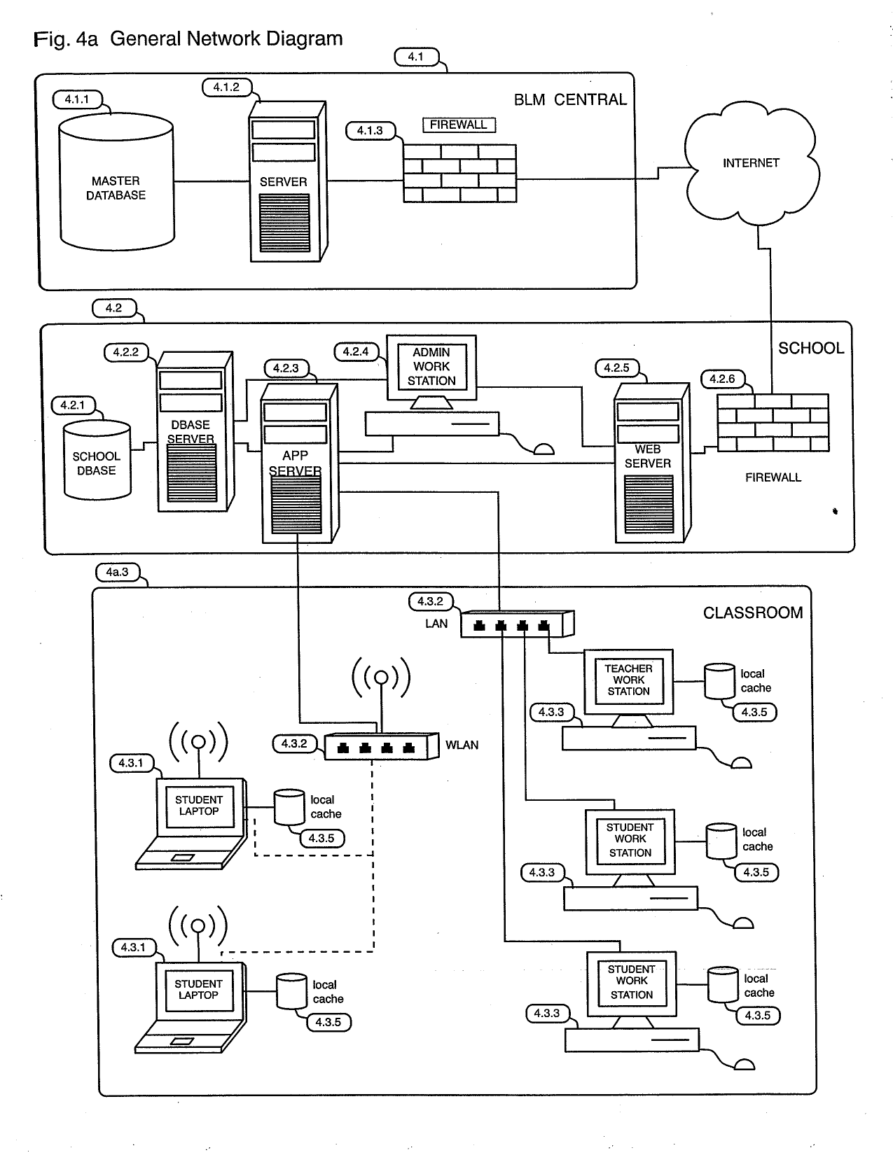

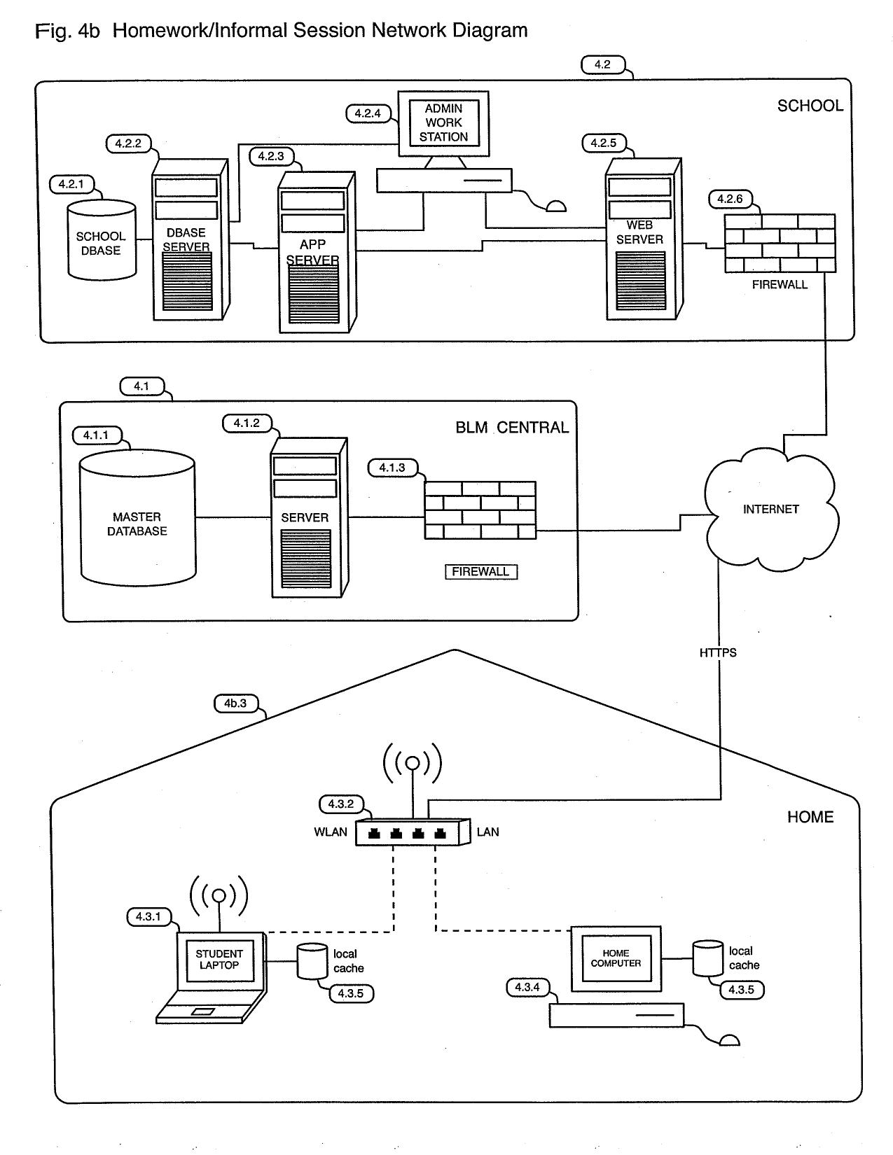

At step 2.1 (FIG. 2), the student may repeat the demonstration on the individual classroom computer 4.3.1, 4.3.3 (FIG. 4a). This will help if the student did not understand something during the first lecture or demonstration (step 1a.2).

At step 2.2, the student begins playing the educational game. The game is designed to teach the lesson to the student and test the student's knowledge. After completing a game, the student may move horizontally across the curriculum matrix (FIG. 1b) from one subject to another at the same level of difficulty (step 2.3). This provides comparative data for analysis of how the student performed in a different subject at the same level of difficulty.

Alternatively, the student may move vertically up and down the curriculum matrix (FIG. 1b) from one level to another in the same subject (step 2.4). This provides comparative data for analysis of how the student performed in the same subject at a different level of difficulty. In addition, this scheme can be used to test the student's ability to apply a given concept in two different fields.

After playing the games (step 2.2), the student may finish the gameplay session (step 2.5) and review the results in a game replay session (step 2.6). The game replay session (step 2.6) will allow the student to review the gameplay session that was just completed and review the performance statistics of the gameplay session. Such a review of the gameplay session allows the student to determine the strengths and weaknesses in the subject matter studied.

After reviewing the gameplay session in step 2.6, the gameplay session and gameplay session statistics are stored on the local cache 4.3.5 of the student's computer 4.3.1, 4.3.3 (FIG. 4a) in step 2.7. This will permit the student to review the gameplay sessions in the future.

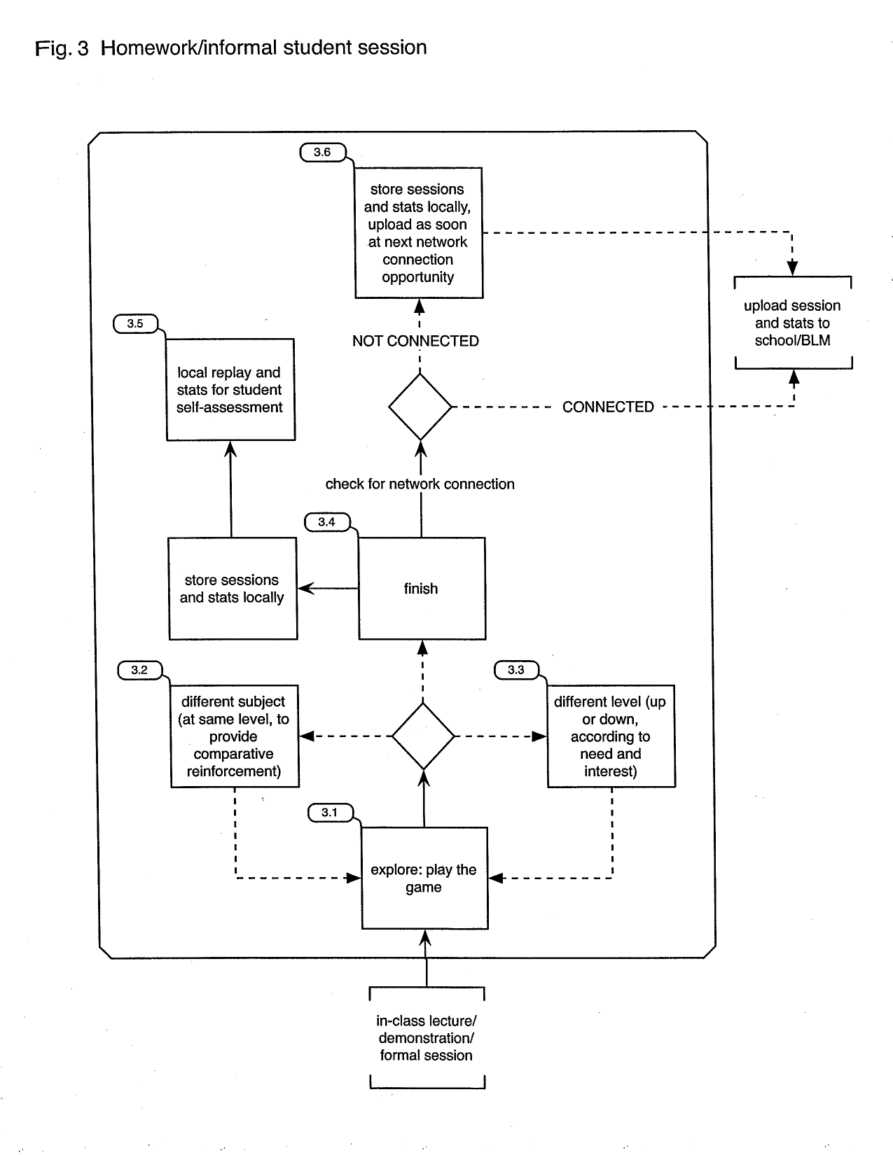

The gameplay session and gameplay session statistics are also uploaded to the school's database 4.2.1 (FIG. 4a) and the BLM master database 4.1.1 (FIG. 4a). After completing the in-class gameplay session (step 2.5), the student may also play the game at home or in an informal student session (FIG. 3).

Returning to FIG. 1a, the student may proceed to a homework or informal student session (step 1a.4) following the in-class lecture (step 1a.2). Alternatively, the student may proceed to a homework session (step 1a.4) following the in-class student session (step 1a.3).

FIG. 3 shows a detailed flow diagram of a homework or informal student session (step 1a.4). At step 3.1, the student may play the game for the chosen lesson. The student may move horizontally across the curriculum matrix (FIG. 1b) in different subjects at step 3.2. Alternatively, the student may move vertically up and down the curriculum matrix (FIG. 1b) to different levels of the same subject in step 3.3.

After completing the gameplay session at step 3.4, the gameplay session and statistics are stored in the local cache 4.3.5 (FIG. 4b) of the student's computer(s) 4.3.1, 4.3.4 (FIG. 4b). At step 3.5, the student can review the gameplay session that was just completed and review the performance statistics of the gameplay session.

Alternatively, after completing the home gameplay session (step 3.4), the system will store the gameplay session and statistics. If the student has a network connection, then the gameplay session and statistics will be immediately uploaded to the school's master database 4.2.1 (FIG. 4b) and the BLM master database 4.1.1 (FIG. 4b). If the student has no network connection, then the gameplay session and statistics will, at step 3.6, be saved in the local cache 4.3.5 (FIG. 4b) for later uploading to the school's master database 4.2.1 (FIG. 4b) and the BLM master database 4.1.1 (FIG. 4b).

Returning to FIG. 1a, the results of the gameplay sessions of the in-class student session (step 1a.3) or the homework session (step 1a.4) will be stored as raw session records 1a.5 that can be stored in a data warehouse 1a.10. Such a data warehouse 1a.10 can be the school database 4.2.1 (FIGS. 4a and 4b) or the BLM master database 4.1.1 (FIGS. 4a and 4b), for example.

From the raw session records 1a.5, the system can generate usage and scoring data 1a.6. Such usage and scoring data 1a.6 can be tailored for use by teachers 1a.7, the school 1a.8, and the school board 1a.9, among others. Teachers, schools, administrators, statisticians, and others can utilize the session records stored in data warehouse 1a.10 to conduct data analysis (step 1a.11) to determine the effectiveness of the curriculum and assess how students are learning across multiple subjects and levels of the curriculum.

At step 1a.12, curriculum designers, teachers, administrators, and others can evaluate the effectiveness of the curriculum and decide what improvements need to be made to the curriculum in order to facilitate learning by the students. Such improvements can involve improving the design of the game itself at step 1a.13 so that students are better able to learn by using the game. The improvements can also involve improving the curriculum design (such as the text 1a.1.3 and media 1a.1.2) of the lessons at step 1a.14.

Accordingly, while the invention has been described with reference to the structures and processes disclosed, it is not confined to the details set forth, but is intended to cover such modifications or changes as may fall within the scope of the following claims.

What is claimed is:

1. A system for evaluating the performance of students in science, technology, engineering, and mathematics subjects comprising:
a) a first student computer;
b) at least one teacher computer;
c) at least one database; and
d) a network connecting the first student computer, teacher computer, and database to one another;
wherein a teacher presents a lecture or demonstration to illustrate the concepts embodied in a curriculum;
wherein a first student plays an educational game said first student computer, said educational game pertaining to the lecture presented by the teacher;
wherein said educational game generates data of said first student's performance in connection with said educational game; and
wherein said curriculum or said educational game is redesigned using said data generated from the educational game.

2. The system of claim 1 wherein the curriculum comprises a plurality of lessons.

3. The system of claim 2 wherein each of said lessons comprises an educational game, a media component, and a text component.

4. The system of claim 1 wherein the curriculum comprises a plurality of subjects and each subject comprises a plurality of levels with progressively more difficult subject matter.

5. The system of claim 4 wherein the first student may, after the completion of the educational game, replay the educational game in a different subject or at a different level of difficulty.

6. The system of claim 1 wherein the first student may, after the completion of the educational game, view a replay of the educational game.

7. The system of claim 1 wherein the first student may, after the completion of the educational game, review statistics related to the performance during the educational game.

8. The system of claim 1 wherein the data generated by the educational game of the first student is aggregated with data generated by the educational game of a second student to produce aggregated data.

9. The system of claim 8 wherein an analyst utilizes the aggregated data to assess how students are learning across multiple subjects and levels of the curriculum.

10. The system of claim 9 wherein the first student and the second student attend different schools.

11. The system of claim 1 further comprising a second student computer.

12. A method for evaluating the performance of students in science, technology, engineering, and mathematics subjects comprising:
a) displaying, by a first computer, a teaching lesson wherein said lesson is part of a broader curriculum;
b) playing an educational game on a second computer, wherein said playing is performed by a first student;
c) generating performance data by a programmable logic unit, said performance data pertaining to the first student's performance on the educational game;
d) storing said performance data, by said programmable logic unit, in a first database; and
e) analyzing said performance data to improve the educational game or the curriculum.

13. The method of claim 12 wherein said curriculum comprises a plurality of lessons.

14. The method of claim 13 wherein each of said lessons comprises an educational game, a media component, and a text component.

15. The method of claim 12 wherein the curriculum comprises a plurality of subjects and each subject comprises a plurality of levels with progressively more difficult subject matter.

16. The method of claim 15 wherein the first student may, after playing the educational game in step (b), replay the educational game in a different subject or at a different level of difficulty.

17. The method of claim 12 wherein the first student may, after playing the educational game in step (b), view a replay of the educational game.

18. The method of claim 12 wherein the first student may, after playing the educational game in step (b), review statistics related to the performance during the educational game.

19. The method of claim 12 wherein said performance data generated in step (c) is aggregated with additional performance data generated by a second student to produce aggregated data.

20. The method of claim 19 wherein said aggregated data is utilized to assess how students are learning across multiple subjects and levels of the curriculum.

21. The method of claim 20 wherein the first student and the second student attend different schools.
